(19) United States
(12) Patent Application Publication
(10) Pub. No.: US 2025/0124078 A1
(43) Pub. Date: Apr. 17, 2025

(54) SpaceGPT: Visual Language Model Empowered Remote Sensing Data Service Platform

(71) Applicant: The Hong Kong University of Science and Technology, Hong Kong (CN)

(72) Inventors: Hui SU, Hong Kong (CN); Weifan XU, Hong Kong (CN)

(21) Appl. No.: 18/911,684

(22) Filed: Oct. 10, 2024

Related U.S. Application Data
(60) Provisional application No. 63/589,987, filed on Oct. 12, 2023.

(51) Int. Cl. G06F 16/535; G06F 40/40

(52) U.S. Cl. CPC G06F 16/535; G06F 40/40

(57) ABSTRACT

Remote sensing satellite data services are limited by lack of data processing and analytic capabilities as current solutions rely on manual interventions, which are inefficient, cost prohibitive for large-scale processing, and prone to human errors. A system that utilizes a large language model to understand user intent and provokes corresponding computer vision models fine-tuned with remote sensing imagery datasets, such as open vocabulary object detection and segmentation model with state-of-the-art model architecture, is provided to enable users to extract useful insights by natural language text query. With such revolutionizing visual language model interaction built on a cloud-native platform, the system is able to help customers access satellite data and gain insights faster and easier than ever, and help companies, governments and civil society use satellite imagery to discover actionable insights regarding important phenomena, such as deforestation, agriculture, climate change, biodiversity, and supply chains worldwide.

### CROSS-REFERENCE TO RELATED APPLICATIONS

This application claims the benefit of U.S. Provisional Patent Application Ser. No. 63/589,987 filed Oct. 12, 2023, the disclosure of which is incorporated by reference herein in its entirety.

### ABBREVIATIONS

AI artificial intelligence
CLIP Contrastive Language-Image Pre-Training
DETR detection transformer
DOTA Dataset for Object Detection in Aerial Images
LLM large language model
OV-DETR Open-Vocabulary Detection Transformer
SAM Segment Anything Model
VFM visual foundation model
VLM vision-language model

### TECHNICAL FIELD

The present disclosure generally relates to a machine learning model. Particularly, the present disclosure relates to a visual language model.

### BACKGROUND

The analysis and application of aerospace big data belongs to the field of aerospace technology. With the advancement of observation and computer technologies, relevant organizations can now obtain massive heterogeneous aerospace data every day. Remote sensing satellite data offers huge potential in providing insights (e.g. asset/commodity/carbon monitoring) for various clients ranging from governments, corporates to individuals. The common data analytics methods for satellite data analysis and data services include feature extraction, image classification, segmentation, object detection, change detection, etc.

The traditional satellite data pre-processing pipeline is limited by lack of data processing and analytic capabilities, as it requires a large amount of manual intervention to extract usable information from massive remote-sensing data, resulting in low production efficiency, prohibitive cost for large scale processing, and is prone to human error. For example, 190,000+ co-seismic surface landslides occurred after Wenchuan Earthquake in 2008, and the current landslide inventory were all from manual identification and compilation, which is very time and labor intensive.

There is a need in the art for an improved technique for extracting usable information from massive remote-sensing data while achieving an increased level of automation in extracting the information so as to reduce an amount of manual intervention that is involved.

### SUMMARY

In the present disclosure, SpaceGPT is introduced for chatting with a user in natural language and processing remote-sensing images according to instructions issued or hinted by the user in a chat made in natural language. SpaceGPT is a unified model capable of learning from multiple label modalities in various datasets including remote-sensing imagery datasets (e.g., object detection and segmentation), with visual-language model capabilities that connect a LLM and one or more VFMs to enable sending and receiving images during chatting. A user can ask the model to perform certain image-related tasks using text queries. Automation in analyzing the remote-sensing images without intervention or assistance by human experts is advantageously achievable.

A first aspect of the present disclosure is to provide a computer-implemented method utilizing SpaceGPT for chatting with a user in natural language and performing an image-related task mentioned or hinted by the user in a query. The image-related task is performed on one or more remote-sensing images.

In the method, a platform for bidirectionally communicating with the user and performing the image-related task is set up in software. The platform comprises a prompt manager for communicating and prompting a LLM. The prompt manager is arranged to: forward the query to the LLM so as to cause the LLM to identify the image-related task from the query and determine one or more image-processing actions to be performed on the one or more remote-sensing images for accomplishing the image-related task; prompt the LLM to provoke a matched VFM selected from a predetermined set of one or more VFMs to perform an individual image-processing action if the LLM determines that the individual image-processing action matches an image-processing operation performable by the matched VFM; and receive from the LLM a reply to the user on any outcome of the image-related task. After the platform is set up, the platform is used to receive the query from the user, process the query and forward the reply to the user. Before the platform is used to process the query, one or more selected VFMs are fine-tuned with one or more remote-sensing imagery datasets. As a result, advantageously, one or more respective image-processing operations performable by the one or more selected VFMs are adapted to or optimized for remote sensing-related image processing. The one or more selected VFMs are selected from the predetermined set of one or more VFMs. It is possible that all VFMs in the predetermined set are selected.

Preferably and advantageously, the one or more selected VFMs are fine-tuned with the one or more remote-sensing imagery datasets in a self-supervised manner.

In certain embodiments, the one or more respective image-processing operations performed by the one or more selected VFMs include one or more operations selected from an image classification operation, an object detection operation and an image segmentation operation.

In certain embodiments, the one or more selected VFMs include one or more of machine-learning models selected from OV-DETR, Grounding Dino and Segment Anything Model.

In certain embodiments, the one or more respective image-processing operations performed by the one or more selected VFMs include one or more operations for detecting or identifying one or more types of hydrological or geomorphological catastrophes.

The one or more types of hydrological or geomorphological catastrophes may include flooding, landsliding, or both.

Preferably and advantageously, the platform is set up in a cloud-computing environment.

In certain embodiments, the platform further comprises a command interface for interfacing with the user. The command interface is arranged to receive the query from the user, forward the received query to the prompt manager and forward the reply to the user. The command interface is a LLM-supported command interface. The command interface may be further arranged to support sending and receiving image files during chatting.

In certain embodiments, the LLM is selected to be ChatGPT.

In certain embodiments, the platform further comprises the LLM and the predetermined set of one or more VFMs such that the platform is self-contained with a visual language model.

A second aspect of the present disclosure is to provide a system for chatting with a user in natural language and performing an image-related task mentioned or hinted by the user in a query during chatting. The image-related task is performed on one or more remote-sensing images.

The system comprises one or more computers networked together. The one or more computers are configured to execute a computing process of chatting with the user in natural language and performing the image-related task as set forth in any of the embodiments of the disclosed method.

Other aspects of the present disclosure are disclosed as illustrated by the embodiments hereinafter.

### BRIEF DESCRIPTION OF THE DRAWINGS

FIG. 1 depicts an example of a user interface of SpaceGPT, where an ordinary user communicates with a LLM of SpaceGPT in natural language, and the user interface shows that SpaceGPT accepts an airport image and returns an output image after accomplishing an image-related task instructed by the user via a query.

FIG. 2 depicts a schematic diagram for illustrating an exemplary structure of SpaceGPT, where the structure is a software model.

FIG. 3 depicts a flowchart illustrating a typical operation of SpaceGPT with a non-limiting example of running SpaceGPT.

FIG. 4 depicts a workflow illustrating exemplary steps of a method that utilizes SpaceGPT to chat with a user in natural language and perform an image-related task mentioned or hinted by the user in a query during chatting.

Skilled artisans will appreciate that elements in the figures are illustrated for simplicity and clarity and have not necessarily been depicted to scale.

### DETAILED DESCRIPTION

The present disclosure is concerned with a remote-sensing data service platform that utilizes a visual language model, which is named as SpaceGPT, for chatting with a user in natural language and processing remote-sensing images according to instructions issued or hinted by the user in a chat made in natural language. Advantageously, automation in analyzing the remote-sensing images without intervention or assistance by human experts is achievable even if the user is a technical layman in computer vision and is not aware of suitable computer-vision operations necessary to be carried out in analyzing the remote-sensing images to achieve a certain high-level purpose. As a result, advantages of time efficiency and cost reduction in analyzing the remote-sensing images are obtained. To realize these advantages, the data service platform utilizes a LLM to understand the user's intent in processing the images and provoke relevant computer-vision AI models fine-tuned on remote sensing imagery datasets, such as open vocabulary object detection and segmentation model with state-of-the-art model architecture, to enable the user to extract useful insights by natural language text query.

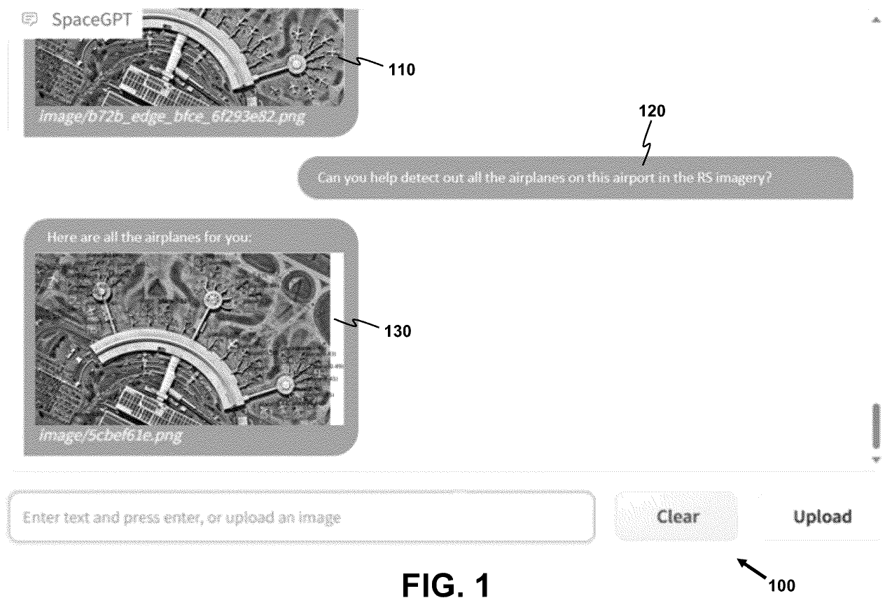

Before proceeding further, it is instructive to provide a short description of how an ordinary user interacts with SpaceGPT in analyzing a remote-sensing image. FIG. 1 depicts an example of a user interface 100 of SpaceGPT, where an ordinary user communicates with a LLM of SpaceGPT in natural language. On the user interface 100, the user uses chat boxes to interact with the LLM in dialogue and instructs SpaceGPT to perform an image-processing task by a natural language query. The user first sends an aerial image 110 of an airport to SpaceGPT, and subsequently asks SpaceGPT with a query 120 in natural language: “Can you help detect out all the airplanes on this airport in the RS imagery?” The LLM interprets the query 120 and understands that SpaceGPT is assigned with a task of identifying all the airplanes appeared on the airport image 110. After this task is accomplished, SpaceGPT provides an outcome of the task by displaying an output image 130 on the user interface 100. In the output image 130, the identified airplanes are each annotated and bounded by a bounding box.

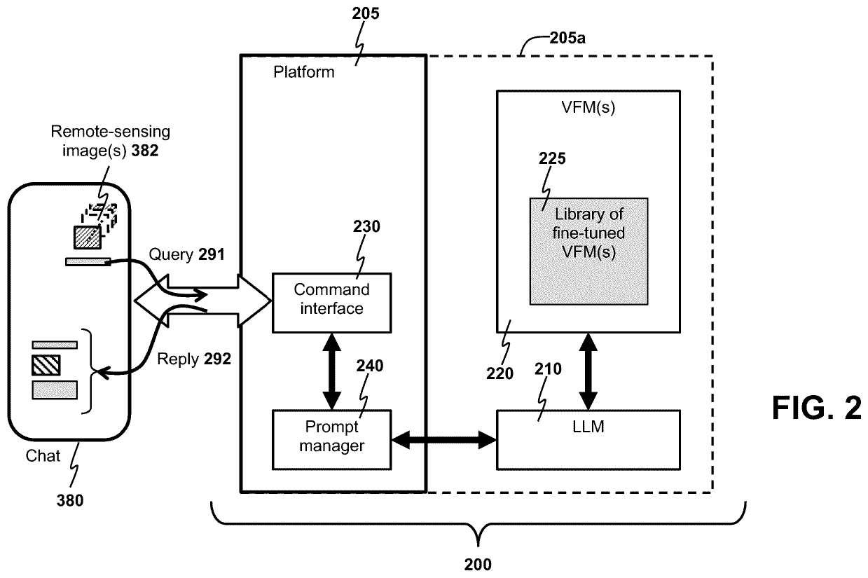

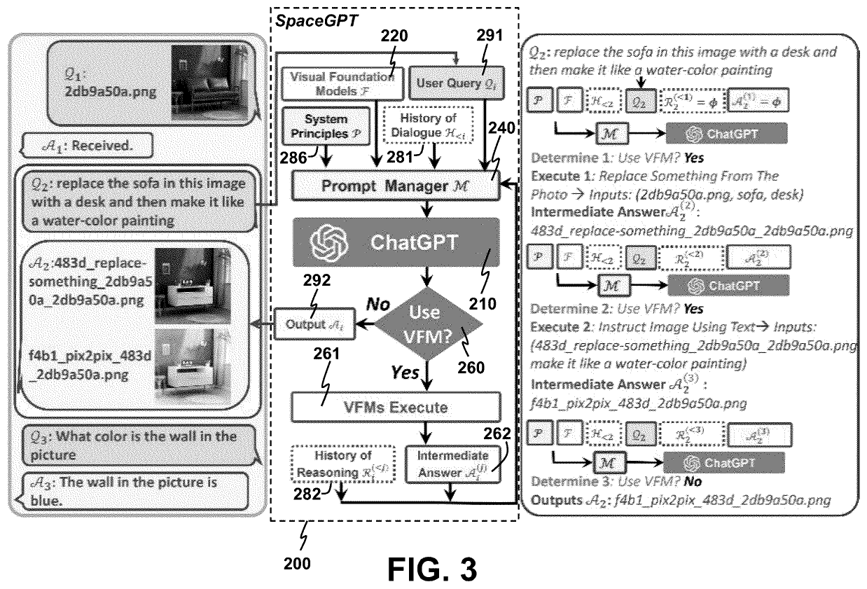

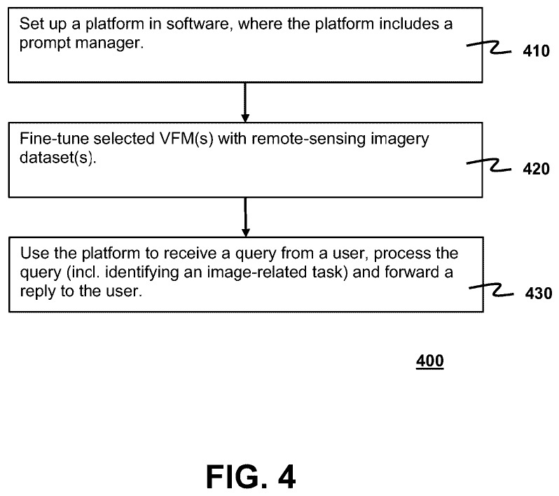

A first aspect of the present disclosure is to provide a computer-implemented method for chatting with a user in natural language and performing an image-related task mentioned or hinted by the user in a query during chatting. The image-related task is performed on one or more remote-sensing images. The disclosed method utilizes SpaceGPT to understand user intent in processing the one or more remote-sensing images so as to determine the image-related task. The disclosed method is exemplarily illustrated with the aid of FIGS. 2-4. FIG. 2 depicts a schematic diagram for illustrating an exemplary structure of SpaceGPT (referenced as 200) and showing an organization of exemplary elements in forming SpaceGPT 200, where the structure shown in FIG. 2 is a software model. FIG. 3 depicts a flowchart illustrating a typical operation of SpaceGPT 200, and a non-limiting example of running SpaceGPT 200. FIG. 4 depicts a workflow 400 that illustrates exemplary steps of the disclosed method. The workflow 400 comprises steps 410, 420 and 430.

The step 410 is an initialization step. In the step 410, a platform 205 used for bidirectionally communicating with the user and performing the image-related task is set up in software. In particular, the platform 205 comprises a prompt manager 240 for communicating and prompting a LLM 210.

The LLM 210 is capable of understanding natural language in order to identify the image-related task from the query (referenced as 291) made by the user in the chat (referenced as 380). The image-related task may be explicitly mentioned in the query 291, or may be “hinted” or “implied” in the query 291 such that the LLM 210 is required to first understand the user's intent from the words of the query 291 and then estimate the image-related task. In addition, the LLM 210 is also capable of determining one or more image-processing actions to be performed on the one or more remote-sensing images (referenced as 382) for accomplishing the image-related task. One practical example of the LLM 210 is ChatGPT.

The prompt manager 240 is arranged (or programmed) to at least perform the following three procedures. First, the prompt manager 240 forwards the query 291 made by the user to the LLM 210. As a result of this forwarding of the query 291, the LLM 210 is triggered or caused to identify the image-related task from the query 291 and to determine one or more image-processing actions to be performed on the one or more remote-sensing images 382 for accomplishing the image-related task. Second, the prompt manager 240 prompts the LLM 210 to provoke a matched VFM selected from a predetermined set of one or more VFMs 220 to perform an individual image-processing action if the LLM 210 determines that the individual image-processing action matches an image-processing operation performable by the matched VFM. Third, the prompt manager 240 receives from the LLM 210 a reply 292 to the user on any outcome of the image-related task.

As shown in FIG. 2, SpaceGPT 200 includes the prompt manager 240, the LLM 210 and the predetermined set of one or more VFMs 220. As a result of this integration, SpaceGPT 200 is a unified model capable of learning from multiple label modalities in various datasets, (e.g., object detection and segmentation), with visual-language model capabilities that connect the LLM 210 such as ChatGPT and VFM(s) 220 such as Grounding Dino to enable sending and receiving images during chatting. That is, the user can ask SpaceGPT 200 to perform certain image-related tasks using text queries.

In practical situations, it is often that the prompt manager 240 is operated by one service provider while the LLM 210 and the one or more VFMs 220 are operated by other service provider(s) or may even be open-access software applications. It is reasonable that the platform 205 does not include the LLM 210 and the VFM(s) 220, as shown in FIG. 2. However, this exclusion is due to non-technical reasons. It is also possible that the LLM 210 and the VFM(s) 220 are incorporated into the platform 205 to form an enlarged platform (as indicated by 205a in FIG. 2). In certain embodiments, the platform 205 further comprises the LLM 210 and the predetermined set of one or more VFMs 220 such that the platform 205 is self-contained with a visual language model (SpaceGPT 200).

Usually, the platform 205 further comprises a command interface 230 for interfacing with the user. The command interface 230 is arranged to receive the query 291 from the user, forward the received query 291 to the prompt manager 240 and forward the reply 292 to the user. Note that the command interface 230 is a LLM-supported command interface, which allows textual communication in natural language between the user and SpaceGPT 200. Note that generally, the command interface 230 is further arranged to support sending and receiving image files during chatting.

Refer to FIG. 4. After the initialization step 410 is performed, the platform 205 is deployed in the step 430 to receive the query 291 from the user, process the query 291 and forward the reply 292 to the user.

It is desirable to customize some selected VFMs in the predetermined set of one or more VFMs 220 to remote sensing-based image processing such that higher levels of performance in performing corresponding image-processing operations can be achieved when compared to non-customized versions of aforementioned selected VFMs. Before the platform 205 is used in the step 430 to process the query 291, or more practically, before the chat 380 is initiated, one or more selected VFMs 225 are fine-tuned with one or more remote-sensing imagery datasets (as training datasets) in the step 420, where the one or more selected VFMs 225 are selected from the predetermined set of one or more VFMs 220. Optionally, all of the one or more VFMs 220 in the predetermined set are selected to be the one or more selected VFMs 225. As an advantageous result, one or more respective image-processing operations performable by the one or more selected VFMs 225 are adapted to or optimized for remote sensing-related image processing. Note that the step 420 is also an initialization step.

Preferably and advantageously, the one or more selected VFMs 225 are chosen such that these VFMs 225 can be fine-tuned in a self-supervised manner. As a result, the time cost of preparing the one or more remote-sensing imagery datasets for the fine-tuning purpose can be made lower in comparison to the case of fully-supervised training.

It is also preferable that the one or more selected VFMs 225 are chosen such that the one or more respective image-processing operations performed by the one or more selected VFMs 225 include one or more operations selected from an image classification operation, an object detection operation and an image segmentation operation. The latter three operations are commonly used in remote sensing-based image processing.

Examples of VFMs 225 that perform any of these three operations include OV-DETR, Grounding Dino and SAM. In certain embodiments, the one or more selected VFMs 225 include one or more of machine-learning models selected from OV-DETR, Grounding Dino and SAM. More details of the latter three machine-learning models are provided as follows.

OV-DETR is an end-to-end transformer-based open-vocabulary detector that formulates a learning objective as a binary matching one between input queries and corresponding objects. It conditions the Transformer decoder on the input embeddings obtained from a pre-trained vision-language model such as CLIP. With fine-tuning CLIP on the remote sensing dataset such as Satlas and DOTA. For more details on OV-DETR, see Y. ZANG, W. LI, K. ZHOU, C. HUANG and C. C. LOY, “Open-Vocabulary DETR with Conditional Matching,” arXiv: 2203.11876 [cs.CV], 2022, the disclosure of which is incorporated by reference herein.

Grounding Dino is an open-set object detector combining transformer-based detector DINO with grounded pre-training to detect arbitrary objects with human inputs such as category names or referring expressions. It accepts an (image, text) pair as inputs, and outputs 900 (by default) object boxes with similarity scores across all input words. Grounding Dino adopts the following architecture: a text backbone, an image backbone, a feature enhancer, a language-guided query selection, and a cross-modality decoder. Grounding Dino serves the object detection task the same as OV-DETR with comparable accuracy and generalization capabilities but different fine-tuning method on remote sensing datasets. Grounding Dino offers an alternative choice when the result of OV-DETR is not satisfactory. For more details on Grounding Dino, see S. LIU et al., “Grounding DINO: Marrying DINO with Grounded Pre-Training for Open-Set Object Detection,” arXiv: 2303.05499 [cs.CV], 2023, the disclosure of which is incorporated by reference herein.

SAM is a promptable segmentation system with zero-shot generalization to unfamiliar objects and images, without the need for additional training. SAM produces high quality object masks from input prompts such as points or boxes, and it can be used to generate masks for all objects in an image. It serves the object segmentation tasks on remote sensing images. For more details on SAM, see A. KIRILLOV, “Segment Anything,” arXiv: 2304.02643 [cs.CV], 2023, the disclosure of which is incorporated by reference herein.

Apart from the image classification operation, object detection operation and image segmentation operation, all of which are usually deemed to be fundamental image-processing tools, it is possible that one or more higher-level image-processing tools directly related to remote sensing are performed in the one or more selected VFMs 225. In certain embodiments, the one or more respective image-processing operations performed by the one or more selected VFMs 225 may include, or may further include, one or more operations for detecting or identifying one or more types of hydrological or geomorphological catastrophes. Specifically, each of the one or more operations is configured to detect or identify a respective type of hydrological, or geomorphological, catastrophes. Examples of hydrological or geomorphological catastrophes include a flooding event and a landslide event. In certain embodiments, the one or more types of hydrological or geomorphological catastrophes include flooding, landsliding, or both. Generally, the aforesaid one or more operations are image-analysis-based operations.

In summary, the one or more selected VFMs 225 obtained after fine-tuning form a remote-sensing fine-tuned AI algorithm library 225, which contains AI models that are fine-tuned on the one or more remote-sensing imagery datasets and are capable of completing common tasks on remote-sensing images, such as image classification, object detection and image segmentation.

Although it is shown in FIG. 4 that the step 410 of setting up the platform 205 precedes the step 420 of fine-tuning the one or more selected VFMs 225, the present disclosure is not limited only to executing the steps 410 and 420 in the aforementioned order. It is possible that the order of executing the steps 410 and 420 is swapped such that the step 420 is executed prior to executing the step 410.

It is instructive to provide an example for illustrating a typical flow of operations performed in SpaceGPT 200 on handling the chat 380 and processing the query 291. Assume that the step 502 has been executed such that the remote-sensing fine-tuned AI algorithm library 225 has been established in the predetermined set of one or more VFMs 220. Refer to FIG. 3. In SpaceGPT 200, the prompt manager 240 receives information on system principles 286 (such as system restrictions) and a knowledge of the predetermined set of one or more VFMs 220. The knowledge of the predetermined set of one or more VFMs 220 enables the prompt manager 240 to prompt the LLM 210 regarding available VFM(s) 220 that can be provoked. When the query 291 is received by the prompt manager 240, the prompt manager 240 forwards the query 291 to the LLM 210. Upon receipt of the query 291, the LLM 210 identifies or estimates the image-related task to be performed through understanding the query 291, and determines an action plan having the one or more image-processing actions to be performed. The LLM 210 iteratively carries out the one or more image-processing actions. In each iteration, the LLM 210 determines if provoking a suitable VFM is required (step 260). If a positive answer is obtained, the aforesaid suitable VFM is executed (step 261) to give an intermediate answer 262. The intermediate answer 262 is then used in a subsequent image-processing action taken in a next iteration. If in any iteration the LLM 210 concludes that no further VFM is to be provoked in accomplishing the image-related task, the reply 292 to the user is prepared by the LLM 210 and sent out to the user. The reply 292 is likely to include the lastly-obtained intermediate answer 262. Optionally, a history of dialogue 281 in the chat 380 and a history of reasoning 282 may be used to assist the LLM 210 to more efficiently or more accurately in accomplishing the image-related task.

Other implementation details of the disclosed method or SpaceGPT 200 are elaborated as follows.

Preferably and advantageously, the platform 205 (or 205a) is set up in a cloud-computing environment. As the platform 205/205a is cloud-native, it enables the user to input desired remote-sensing image data or data stream on a cloud or in a user device (such as a tablet) owned by the user to perform machine learning analytics, with visual ChatGPT interaction, to discover actionable insights.

Those skilled in the art will appreciate that the platform 205 (or 205a) may be implemented by appropriate programming on a computer system or equivalent. The computer system may be a computer or a group of plural computers networked together. An individual computer may be a general-purpose computer, a computer equipped with specialized AI computation processor(s), a desktop computer, a mobile computing device, a computing server, a distributed server (as realized in a cloud-computing environment), or any computing device. Networking the aforesaid plural computers may be networked by cables or optical fibers, or may be networked wirelessly. The aforesaid plural computers may be networked on the Internet.

Image files of the one or more remote-sensing images 382 may be uploaded to SpaceGPT 200 by the user through the command interface 230. If the one or more remote-sensing images 382 are stored at a location (e.g., at a storage device accessible through the Internet), the user may only need to provide an address of the location to SpaceGPT 200.

A second aspect of the present disclosure is to provide a system for chatting with a user in natural language and performing an image-related task mentioned or hinted by the user in a query during chatting, where the image-related task is performed on one or more remote-sensing images.

The system comprises one or more computers networked together. The one or more computers are configured to execute a computing process of chatting with the user in natural language and performing the image-related task according to any of the embodiments of the disclosed method as elaborated above in describing the workflow 400.

Details related to the one or more computers and a network that networks these computers together are mentioned above.

As final remarks, advantages of SpaceGPT 200 are summarized as follows.

Firstly, SpaceGPT 200 enables high accuracy open vocabulary object detection and segmentation on remote sensing satellite images. With state-of-the-art model architecture, the object detection and segmentation models are trained and fine-tuned on multiple large-scale remote-sensing imagery datasets with a self-supervised manner, which ideally achieve comparable accuracy with closed-set object detection and segmentation models. It enables the disclosed visual language model 200 to generalize beyond the limited number of base classes labeled during the training phase, and the user can detect and segment common objects in remote-sensing imagery beyond the base classes. That is, the user is likely to be able to successfully detect a target object even if a training dataset used for training SpaceGPT 200 does not contain the target object. SpaceGPT 200 helps the remote-sensing data analytics avoid limitations imposed by using a small number of high-quality remote-sensing image datasets due to variability of remote-sensing image in scale, resolution and elevation angles.

Secondly, SpaceGPT 200 allows a query to be made in natural language, with little or no prior knowledge of remote sensing satellite data characteristics. SpaceGPT 200 utilizes the cutting-edge multi-modality VLM with both text and image understandings for the user to carry out object detection and segmentation tasks via using natural language text queries. The LLM 210 is able to understand user intent and provoke corresponding computer vision model(s), such as object detection or segmentation. This functionality of SpaceGPT 200 offers revolutionary big-data insight-generation experience for users, even if these users are new to remote-sensing image processing.

Thirdly, SpaceGPT 200 built on a cloud-native platform is able to help all users, regardless of levels of expertise they may have, access satellite data and gain insights faster and easier than ever. It also helps companies, governments and civil society use satellite imagery to discover actionable insights regarding important phenomena, such as deforestation, agriculture, climate change, biodiversity, and supply chains worldwide.

The present disclosure may be embodied in other specific forms without departing 1from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer-implemented method for chatting with a user in natural language and performing an image-related task mentioned or hinted by the user in a query, the image-related task being performed on one or more remote-sensing images, the method comprising:
setting up, in software, a platform used for bidirectionally communicating with the user and performing the image-related task, wherein the platform comprises a prompt manager for communicating and prompting a large language model (LLM), the prompt manager being arranged to:
forward the query to the LLM so as to cause the LLM to identify the image-related task from the query and determine one or more image-processing actions to be performed on the one or more remote-sensing images for accomplishing the image-related task;
prompt the LLM to provoke a matched visual foundation model (VFM) selected from a predetermined set of one or more VFMs to perform an individual image-processing action if the LLM determines that the individual image-processing action matches an image-processing operation performable by the matched VFM; and
receive from the LLM a reply to the user on any outcome of the image-related task;
using the platform to receive the query from the user, process the query and forward the reply to the user; and
before the platform is used to process the query, fine-tuning one or more selected VFMs with one or more remote-sensing imagery datasets such that one or more respective image-processing operations performable by the one or more selected VFMs are adapted to or optimized for remote sensing-related image processing, wherein the one or more selected VFMs are selected from the predetermined set of one or more VFMs.

2. The method of claim 1, wherein the one or more selected VFMs are fine-tuned with the one or more remote-sensing imagery datasets in a self-supervised manner.

3. The method of claim 1, wherein the one or more respective image-processing operations performed by the one or more selected VFMs include one or more operations selected from an image classification operation, an object detection operation and an image segmentation operation.

4. The method of claim 1, wherein the one or more selected VFMs include one or more of machine-learning models selected from OV-DETR, Grounding Dino and Segment Anything Model.

5. The method of claim 1, wherein the one or more respective image-processing operations performed by the one or more selected VFMs include one or more operations for detecting or identifying one or more types of hydrological or geomorphological catastrophes.

6. The method of claim 5, wherein the one or more types of hydrological or geomorphological catastrophes include flooding, landsliding, or both.

7. The method of claim 1, wherein the platform is set up in a cloud-computing environment.

8. The method of claim 1, wherein the platform further comprises a command interface for interfacing with the user, the command interface being arranged to receive the query from the user, forward the received query to the prompt manager and forward the reply to the user.

9. The method of claim 8, wherein the command interface is further arranged to support sending and receiving image files during chatting.

10. The method of claim 1, wherein the LLM is selected to be ChatGPT.

11. The method of claim 1, wherein the platform further comprises the LLM and the predetermined set of one or more VFMs such that the platform is self-contained with a visual language model.

12. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 1.

13. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 2.

14. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 3.

15. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 4.

16. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 5.

17. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 6.

18. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 7.

19. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 8.

20. A system for chatting with a user in natural language and performing an image-related task mentioned or hinted by the user in a query during chatting, the image-related task being performed on one or more remote-sensing images, the system comprising one or more computers networked together, wherein the one or more computers are configured to execute a computing process of chatting with the user in natural language and performing the image-related task according to the method of claim 9.
